(19) United States
(12) Patent Application Publication
(10) Pub. No.: US 2009/0023526 A1
(43) Pub. Date: Jan. 22, 2009

(54) PNEUMATIC BASE FOR FACILITATING THE INSTALLATION AND TENSIONING OF A DRIVE BELT

(76) Inventor: Gilles Larouche, St-Honore (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/780,222

(22) Filed: Jul. 19, 2007

(51) Int. Cl. F16H 7/08

(52) U.S. Cl. 474/101

(57) ABSTRACT

A belt tensioner comprises a belt trained on a drive pulley driven by a drive unit mounted on a base supported on an air-spring bellows linearly extendable under fluid pressure from a collapsed position to an extended position to cause joint movement of the base, the drive unit and the drive pulley and thereby change the tension in the belt. A pressure regulator is operatively connected to the air-spring bellows for regulating the fluid pressure in the air-spring bellows such as to maintain the tension substantially constant in the belt during use.

### FIELD OF THE INVENTION

The present invention generally relates to drive belt transmission and, more particularly, to belt tensioning devices.

### BACKGROUND OF THE ART

In belt drive systems, the tension in the drive belt must be maintained above a predetermined level to avoid slippage between the belt an the pulleys. During use, various factors, such as wear, heat and vibrations may have an impact on the level of tension in the belt. Accordingly, various belt tenisoners have been developed over the years to maintain a desired tension in the belt. Such belt tensioners are typically provided in the form of a belt engaging roller mounted at the distal end portion of an actuator and disposed to engage the belt between two pulleys. The actuator is set to urge the roller in contact with the belt in a belt tensioning direction with a force selected to appropriately tension the belt.

Such system offers from several drawbacks. For instance, they do not provide for easy installation and removal of a drive belt. Also, they tend to neutralize the vibrations transmitted to the belt by the drive unit instead of suppressing the vibrations at the source. Finally, conventional belt tensioners are provided as additional parts to be installed for the single purpose of tensioning the belt and as such they contribute to increase the installation costs and times.

### SUMMARY

It is therefore and aim of the present invention to address the above mentioned concerns.

Therefore, in accordance with a general aspect, there is provided a power transmission belt arrangement comprising a power unit mounted on a pneumatic base, the pneumatic base comprising at least one pneumatic actuator and a power unit mounting plate mounted for pivotal movement about a pivot axis, the pneumatic actuator being displaceable between a collapsed position and an extended position to cause pivotable movement of the power unit mounting plate with the power unit fixedly mounted thereon, a drive pulley mounted to a rotating output shaft of said power unit, a belt trained on a drive pulley and extending around a driven pulley for transmitting a torque from said output shaft to said driven pulley, whereby pivotal movement of said power unit mounting plate via actuation of said pneumatic actuator provides for the adjustment of the distance between the drive pulley and the driven pulley and therefore for the adjustment of the tension in the belt.

In accordance with another general aspect, there is provided a belt tensioner comprising a belt trained on a drive pulley driven by a drive unit mounted on a base supported on at least one air-spring bellows linearly extendable under fluid pressure from a collapsed position to an extended position to cause joint movement of the base, the drive unit and the drive pulley and thereby change the tension in the belt; and a pressure regulator operatively connected to said at least one air-spring bellows for regulating the fluid pressure in said air-spring bellows at a fixed value such as to maintain the tension substantially constant in said belt during use.

In accordance with a further general aspect, there is provided a method of maintaining a desired tension in a drive belt extending around a drive pulley and at least one driven pulley, the drive pulley being mounted on a rotating shaft of a drive unit; the method comprising: mounting the drive unit on a pneumatic base including at least one pneumatic actuator displaceable between a retracted position and an extended position, the movement of the pneumatic actuator varying the distance between the drive pulley and the driven pulley, and setting the pressure of the pneumatic actuator at a fixed value corresponding to the desired to the desired tension in the belt, whereby belt tension fluctuations are automatically compensated by a corresponding extension variation of the pneumatic actuator.

### BRIEF DESCRIPTION OF THE DRAWINGS

FIG. 1 is a perspective view of a drive belt arrangement in accordance with one embodiment of the present invention; and

FIG. 2 is an end view of the drive belt arrangement shown in FIG. 1.

### DESCRIPTION OF THE PREFERRED EMBODIMENTS

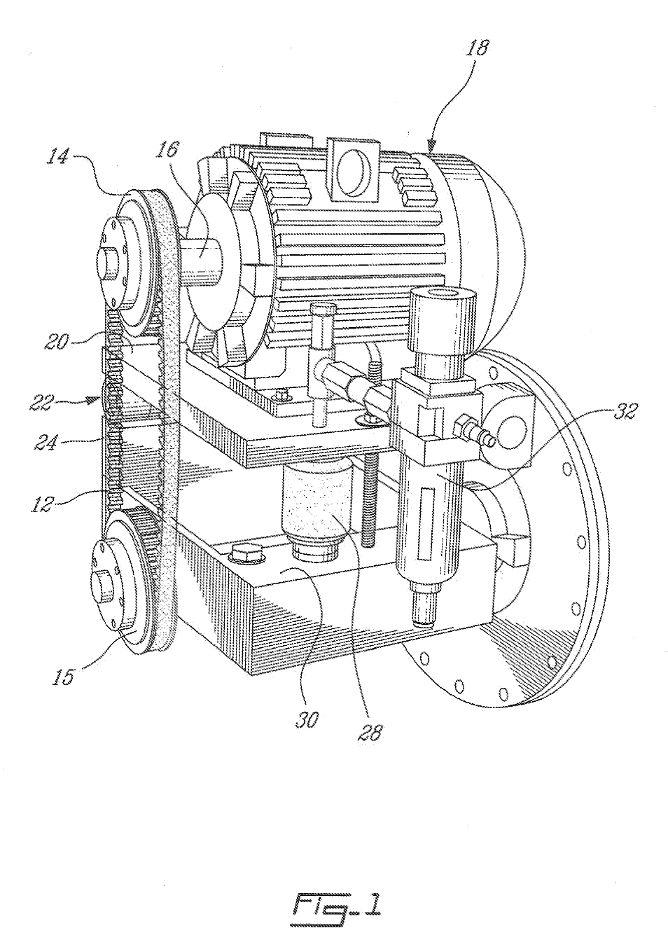

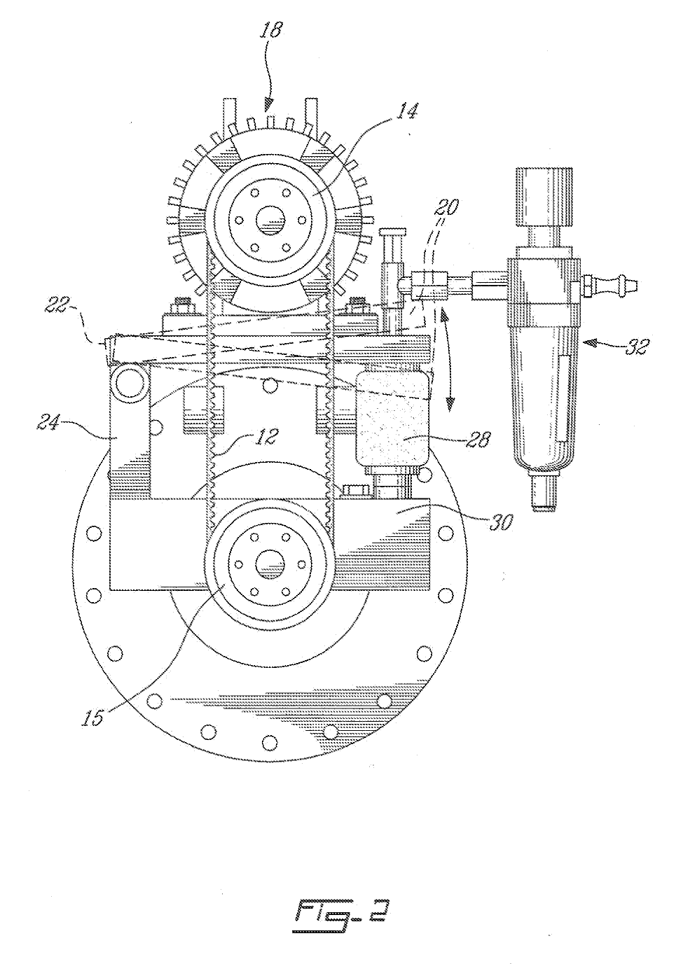

FIG. 1 shows a power transmission or drive belt arrangement comprising an endless belt 12 extending over a drive pulley 14 and a driven pulley 15. The drive pulley 14 is keyed or otherwise secured to the output shaft 16 of a motor 18. The motor 18 is fixedly mounted on a pneumatic base comprising a horizontally disposed mounting plate 20 which is, in turn, pivotally mounted along a first side 22 to a vertically oriented stationary plate 24. As shown in FIG. 2, the pivot can be provided in the form of a hinge mounted between the undersurface of the mounting plate 20 and the vertically oriented stationary plate 24. The hinge provides a fixed horizontal pivotal axis for the mounting plate 20. Other suitable orientation and pivot arrangement could be used as well.

The pneumatic base of the motor 18 further comprises at least one fluidly driven actuator, such as the air-spring bellows 28 shown in FIG. 1. The air-spring bellows 28 is installed underneath the mounting plate 20. The air-spring bellows 28 can be inflated and deflated between extended and collapsed positions to cause upward or downward pivotal movement of the mounting plate 20. By so pivoting the mounting plate 20, the drive pulley 14 can be displaced towards or away from the driven pulley 15, thereby providing for the adjustment of the tension in the drive belt 12. The air-spring bellows 28 is mounted between a stationary bottom surface 30 and the mounting plate 20 at a second side of the mounting plate opposite the first side 22 thereof (i.e. opposite the pivot). The air-spring bellows 28 could, for instance, consists of Air Spring model Y1-1S3 manufactured by ENDINE Inc. Airstroke™ actuators or Airmount™ isolaters manufactured by Firestone Industrial Product Company could be used as well. It is noted that the expression “air-spring bellows” is herein intended to broadly refer to elastomers or rubber-like bellows adapted to contain a column of a compressed fluid. A wide variety of actuation media such as air, water, nitrogen and other suitable pressurized liquid or gas could be used. Therefore, the expressions “air-spring bellows” or “pneumatic” should not be construed as only referring to air as the actuation media.

A pressure regulator 30 is operatively connected to the air-spring bellows 28 to adjust the pressure therein according to the desired level of tension in the drive belt 12. The pressure regulator 30 is mounted in a fluid line of a fluid pressure source (typically a source of compressed gas, such as compressed air). The pressure regulator 30 is of standard construction and typically comprises a valve set to maintain the pressure constant in the air-spring bellows irrespective of the volume variations of the bellows.

In use, the air-spring bellows 28 is first deflated or at least partly deflated to permit easy installation of the belt over the pulleys 14 and 15. Then, the air-spring bellows 28 is inflated to cause the mounting plate 20 to pivot upwardly so as to increase the distance between the pulleys 14 and 15 until reaching the desired tension in the belt 12. The tension in the belt 12 is electronically measured using any appropriate sensing tool. Once the desired tension in the belt has been obtained, the regulator 30 is adjusted to constantly maintain the air-spring bellows 28 at an internal pressure corresponding to the desired tension in the belt 12. Belt wear, heat variations, vibrations as well as other factors may produce variations in the length of the belt 12, which length variations are automatically compensated by a corresponding variation of the volume, and, thus, of the height of the air-spring bellows 28. For instance, in the event of an increase of the length-of the belt 12, the pressure exerted on the air-spring bellows 28 will decrease and since the internal pressure of the air-spring bellows 28 is maintained at a predetermined set value by the pressure regulator 30, the volume of the air-spring bellows 28 will automatically expand, thereby increasing the distance between the pulleys 14 and 15 and compensating for the belt length increase. In this way, the tension in the belt 12 can be maintained constant at all time irrespective of belt length variations and that without the intervention of an operator. This prevents slippage between the belt 12 and the pulleys 14 and 15. A worn belt can be readily replaced by simply releasing pressure from the air-spring bellows to displace same towards its collapsed position. The worn belt can then be removed from the pulleys 14 and 15 and a new one installed therearound without requiring any other adjustments.

The positioning of the air-spring bellows underneath the motor is advantageous in that it provide a damping base for the motor which allows reducing the vibrations on all the parts of the system. This contributes to increase the service life of all the parts. It also contributes to reduce the occupational noise in the plant where the belt drive arrangement is installed. The above described pneumatic base thus solves several problems all at once.

The above description is meant to be exemplary only, and one skilled in the art will recognize that changes may be made to the embodiments described without department from the scope of the invention disclosed. For instance, it is understood that motor 18 could be replaced with any other suitable types of power or driving units. Also, it is understood that the motor 18 and the air-spring bellows 28 could be vertically oriented as opposed to the illustrated horizontally disposed installation. Other installation angles are contemplated as well. Finally, it is understood that more than one air-spring bellows could be provided underneath the mounting plate 20. Other modifications which fall within, the scope of the present invention will be apparent to those skilled in the art, in light of a review of this disclosure, and such modifications are intended to fall within the appended claims.

What is claimed is:

1. A power transmission belt arrangement comprising a power unit mounted on a pneumatic base, the pneumatic base comprising at least one pneumatic actuator and a power unit mounting plate mounted for pivotal movement about a pivot axis, the pneumatic actuator being displaceable between a collapsed position and an extended position to cause pivotal movement of the power unit mounting plate with the power unit fixedly mounted thereon, a drive pulley mounted to a rotating output shaft of said power unit, a belt trained on the drive pulley and extending around a driven pulley for transmitting a torque from said output shaft to said driven pulley, whereby pivotal movement of said power unit mounting plate via actuation of said pneumatic actuator provides for the adjustment of the distance between the drive pulley and the driven pulley and therefore for the adjustment of the tension in the belt.

2. The power transmission belt arrangement of claim 1, further comprising a pressure regulator for regulating the pressure of the pneumatic actuator.

3. The power transmission belt arrangement of claim 2, wherein the pressure regulator is mounted between a fluid pressure source and the pneumatic actuator, and wherein the pressure regulator is set at a predetermined pressure corresponding to a desired tension in the belt.

4. The power transmission belt arrangement of claim 1, wherein said pneumatic actuator comprises at least one air-spring bellows.

5. The power transmission belt arrangement of claim 4, wherein said air-spring bellows is mounted underneath said power unit mounting plate at a distance from said pivot axis.

6. A belt tensioner comprising a belt trained on a drive pulley driven by a drive unit mounted on a base supported on at least one air-spring bellows linearly extendable under fluid pressure from a collapsed position to an extended position to cause joint movement of the base, the drive unit and the drive pulley and thereby change the tension in the belt; and a pressure regulator operatively connected to said at least one air-spring bellows for regulating the fluid pressure in said air-spring bellows such as to maintain the tension, substantially constant in said belt during use.

7. The belt tensioner of claim 6, wherein said base is pivotally mounted along one side thereof opposite to said air-spring bellows.

8. The belt tensioner of claim 6, wherein a plurality of air-spring bellows are mounted behind said base.

9. A method of maintaining a desired tension in a drive belt extending around a drive pulley and at least one driven pulley, the drive pulley being mounted on a rotating shaft of a drive unit; the method comprising: mounting the drive-unit on a pneumatic base including at least one pneumatic actuator displaceable between a retracted position and an extended position, the movement of the pneumatic actuator varying the distance between the drive pulley and the driven pulley, and setting the pressure of the pneumatic actuator at a fixed value corresponding to the desired tension in the belt, whereby belt tension fluctuations are automatically compensated by a corresponding extension variation of the pneumatic actuator.

10. The method of claim 9, wherein setting the pressure comprises regulating the fluid pressure via a pressure regulator mounted between the pneumatic actuator and a source of fluid pressure.

11. The method of claim 10, wherein said pneumatic actuator comprises an inflatable bellows, and wherein setting the pressure comprises initially measuring the tension in the belt while gradually inflating said bellows towards said extended position, and upon reaching the desired tension in the belt, adjusting the pressure regulator to maintain a corresponding level of pressure in the bellows.

12. The method of claim 9, wherein the pneumatic base comprise a drive unit mounting plate, and wherein the method further comprises pivotally mounting the drive unit mounting plate for pivotal movement abut a pivotal axis, and installing the pneumatic actuator underneath said drive unit mounting plate at a location spaced from said pivot axis.
